(19) United States
(12) Patent Application Publication
(10) Pub. No.: US 2009/0265986 A1
(43) Pub. Date: Oct. 29, 2009

(54) Helical Plant Growing System

(76) Inventor: Nolan W. Young, Yulee, FL (US)

Correspondence Address: NEUSTEL LAW OFFICES, LTD., 2534 SOUTH UNIVERSITY DRIVE, SUITE 4, FARGO, ND, 58103, US

(21) Appl. No.: 12/110,393

(22) Filed: Apr. 28, 2008

(51) Int. Cl. A01G 31/02; A01G 31/00; A01G 27/02

(52) U.S. Cl. 47/62 R; 47/39; 47/65

(57) ABSTRACT

A helical plant growing system for efficiently growing various types of plants. The helical plant growing system generally includes a reservoir, a support column including a passageway, wherein the support column is fluidly connected to the reservoir. A pump is fluidly connected between the reservoir and the support column. A plant bed extends outwardly from the support column opposite the reservoir, wherein the plant bed is comprised of a helical configuration.

### CROSS REFERENCE TO RELATED APPLICATIONS

Not applicable to this application.

### STATEMENT REGARDING FEDERALLY SPONSORED RESEARCH OR DEVELOPMENT

Not applicable to this application.

### BACKGROUND OF THE INVENTION

1. Field of the Invention

The present invention relates generally to plant growing systems and more specifically it relates to a helical plant growing system for efficiently growing various types of plants.

2. Description of the Related Art

Any discussion of the prior art throughout the specification should in no way be considered as an admission that such prior art is widely known or forms part of common general knowledge in the field.

Plant growing systems have been in use for years. Typically, plants are grown in a variety of manners and utilizing various types of apparatuses, such as but not limited to pots with soil or fertilizer, within the ground or by the use of mineral nutrient solutions (i.e. hydroponically). The use of hydroponics to grow plants has become increasing popular for various reasons, such as but not limited to allowing the plants to grow in places where plants have not traditionally been able to grow (e.g. underground, soil free areas, etc.), ease and control of growing the plants and various others.

Prior hydroponic plant growing devices have various shortfalls, however, such as but not limited to the prior devices consuming an excess amount of energy, not efficiently distributing the mineral nutrient solution, high in cost and various others. Because of the inherent problems with the related art, there is a need for a new and improved method for plant growing systems to efficiently grow various types of plants.

### BRIEF SUMMARY OF THE INVENTION

The general purpose of the present invention is to provide a helical plant growing system that has many of the advantages of the plant cultivation systems mentioned heretofore. The invention generally relates to a plant cultivation system which includes a reservoir, a support column including a passageway, wherein the support column is fluidly connected to the reservoir. A pump is fluidly connected between the reservoir and the support column. A plant bed extends outwardly from the support column opposite the reservoir, wherein the plant bed is comprised of a helical configuration.

There has thus been outlined, rather broadly, some of the features of the invention in order that the detailed description thereof may be better understood, and in order that the present contribution to the art may be better appreciated. There are additional features of the invention that will be described hereinafter and that will form the subject matter of the claims appended hereto.

In this respect, before explaining at least one embodiment of the invention in detail, it is to be understood that the invention is not limited in its application to the details of construction or to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

An object is to provide a helical plant growing system for efficiently growing various types of plants.

Another object is to provide a helical plant growing system that is able to generate a substantial amount of its own energy thus substantially alleviating the need to utilize batteries or AC power.

An additional object is to provide a helical plant growing system that is easy to utilize.

A further object is to provide a helical plant growing system that is fully automated.

Another object is to provide a helical plant growing system that may be utilized in small areas where space is in short supply.

Other objects and advantages of the present invention will become obvious to the reader and it is intended that these objects and advantages are within the scope of the present invention. To the accomplishment of the above and related objects, this invention may be embodied in the form illustrated in the accompanying drawings, attention being called to the fact, however, that the drawings are illustrative only, and that changes may be made in the specific construction illustrated and described within the scope of the appended claims.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 is an upper perspective view of the present invention.

FIG. 2 is an upper perspective view of the present invention illustrating the plant bed rotating and the fluid in motion.

FIG. 3 is an exploded upper perspective view of the present invention.

FIG. 4 is a longitudinal cross-sectional view of the present invention.

FIG. 5 is an exploded upper perspective view of an alternate embodiment of the present invention.

FIG. 6 is a longitudinal cross-sectional view of an alternate embodiment of the present invention.

FIG. 7 is a longitudinal cross-sectional view of the buoyant transfer assembly, wherein the air is being transferred from the first transfer unit to the second transfer unit to make the second transfer unit buoyant.

FIG. 8 is a longitudinal cross-sectional view of the buoyant transfer assembly, wherein the second transfer unit is rising towards the upper end of the support column and pushing fluid within the overflow unit.

FIG. 9 is a longitudinal cross-sectional view of the buoyant transfer assembly, wherein the second transfer unit is at the upper end of the support column and the fluid spilling out of the overflow unit.

FIG. 10 is a longitudinal cross-sectional view of the buoyant transfer assembly, wherein the second transfer unit is engaging the stopper member thus allowing fluid to fill within the second transfer unit.

FIG. 11 is a longitudinal cross-sectional view of the buoyant transfer assembly, wherein the second transfer unit is filled with fluid and is sinking towards the lower end of the support column.

FIG. 12 is a longitudinal cross-sectional view of the buoyant transfer assembly, wherein the second transfer unit is at the lower end of the support column and about to engage the actuating mechanism.

FIG. 13 is an upper perspective view of an alternative embodiment of the present invention.

### DETAILED DESCRIPTION OF THE INVENTION

### A. Overview

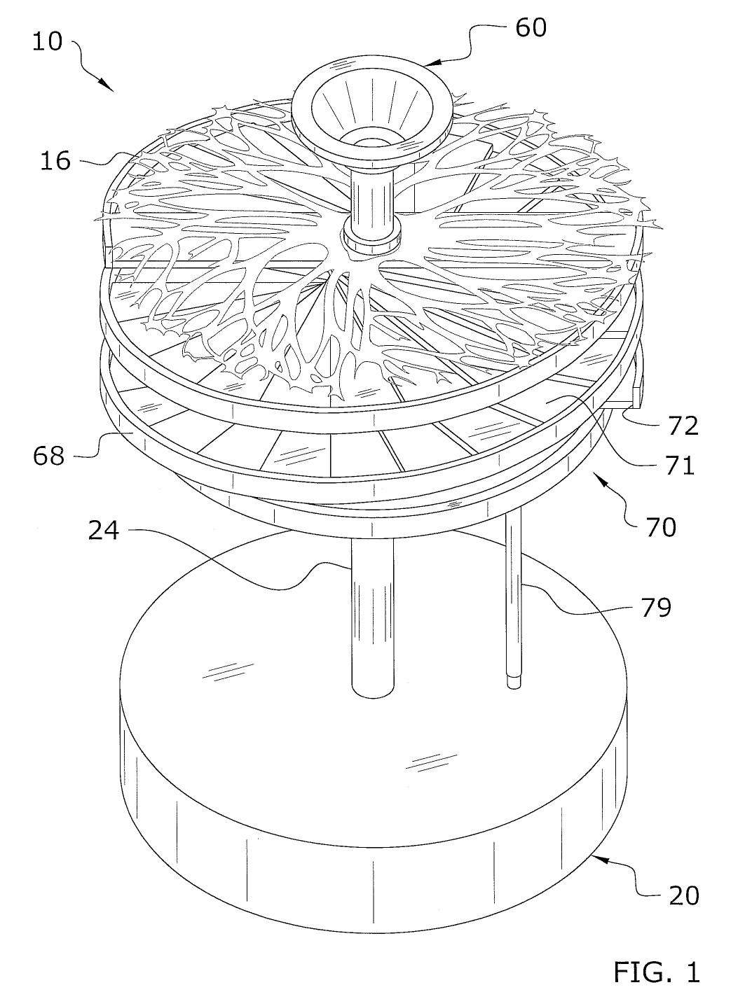

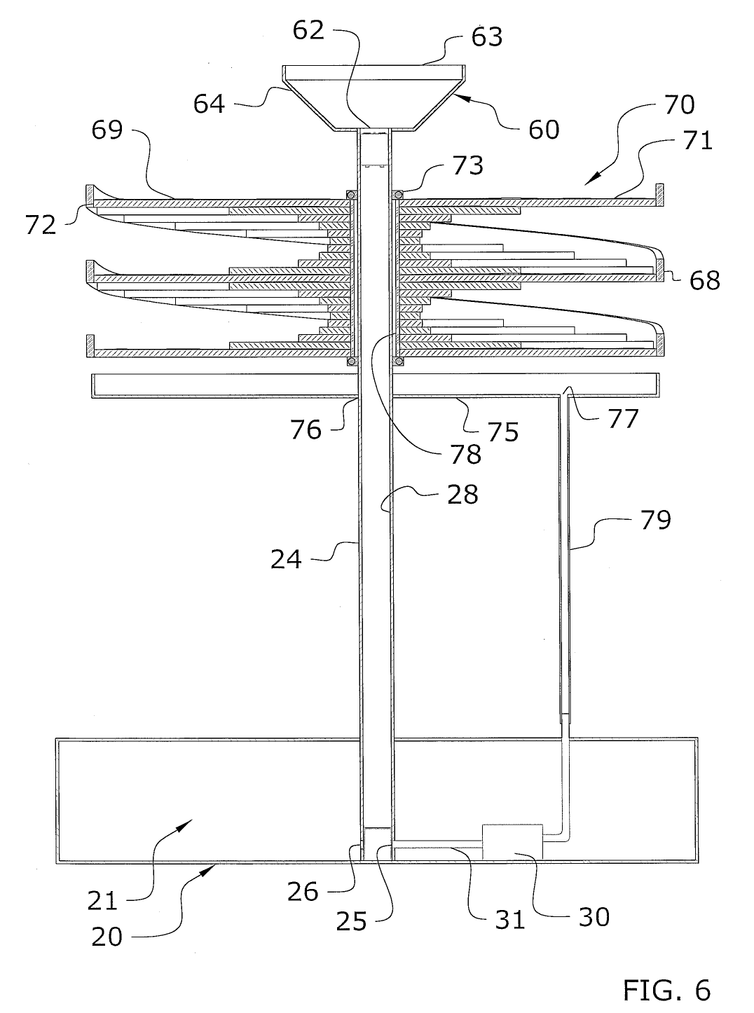

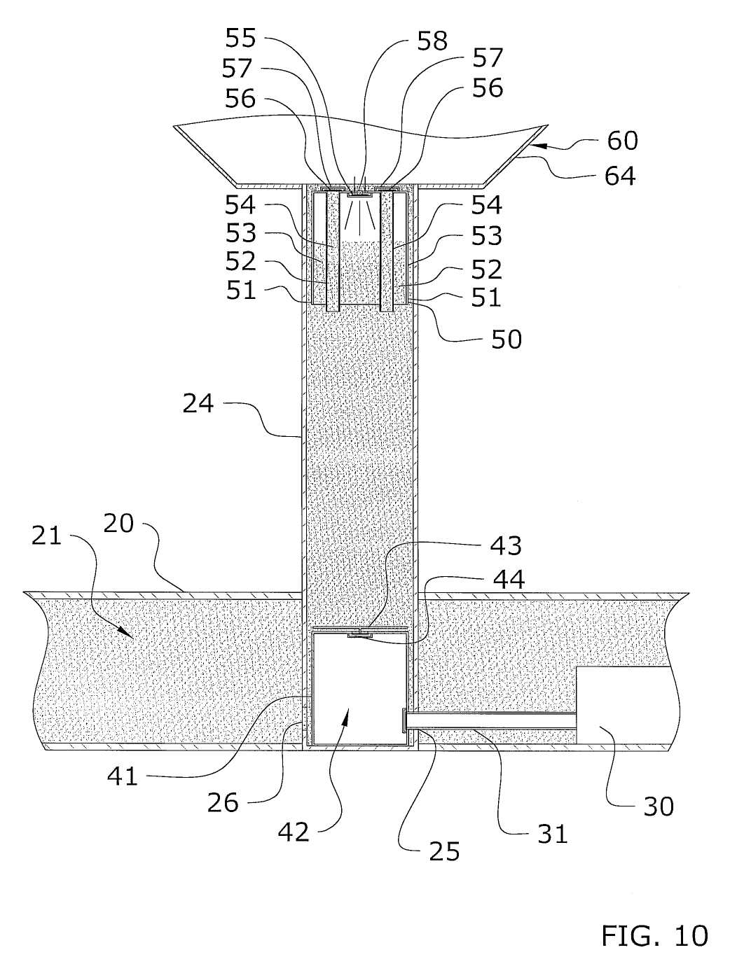

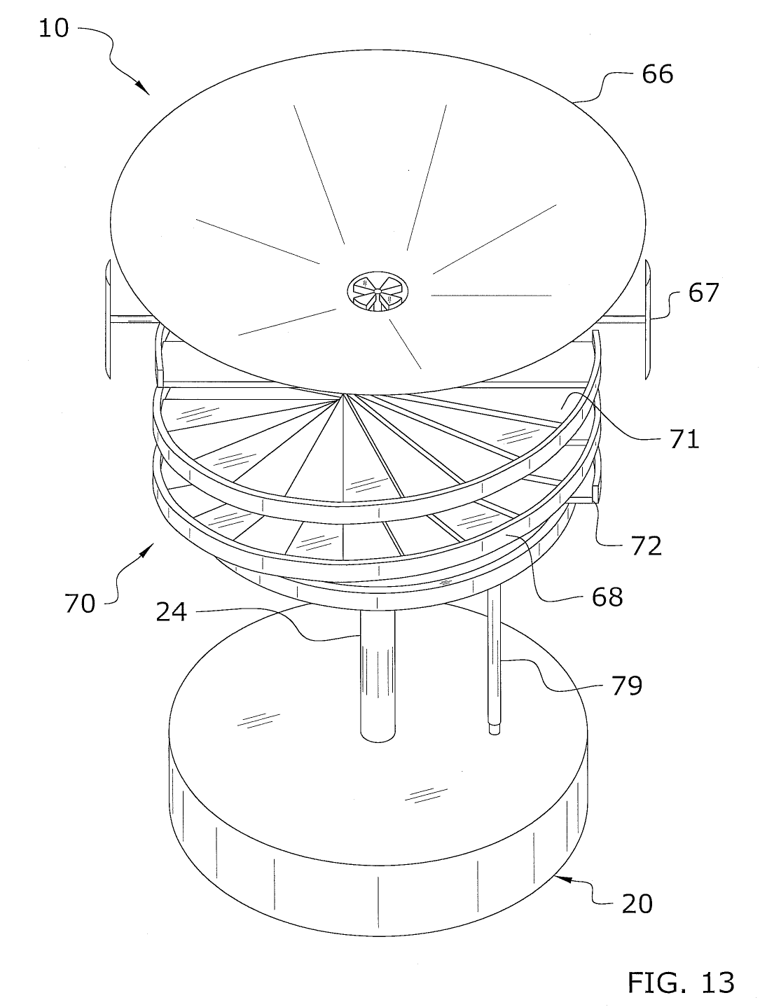

Turning now descriptively to the drawings, in which similar reference characters denote similar elements throughout the several views, FIGS. 1 through 13 illustrate a helical plant growing system 10, which comprises a reservoir 21, a support column 24 including a passageway 28, wherein the support column 24 is fluidly connected to the reservoir 21. A pump 30 is fluidly connected between the reservoir 21 and the support column 24. A plant bed 70 extends outwardly from the support column 24 opposite the reservoir 21, wherein the plant bed 70 is comprised of a helical configuration.

### B. Base

The base 20 of the present invention supports the present invention upon the ground, tabletop surface of various other types of surfaces. The base 20 may also be buried within the ground to conceal the base 20 from being viewed. The base 20 includes a reservoir 21 extending within the base 20 as illustrated in FIGS. 1 through 4. The reservoir 21 temporarily holds the fluid 12 as the fluid 12 is being transferred to the plant bed 70. The fluid 12 utilized with the present invention is preferably comprised of a nutrient solution commonly utilized to hydroponically grow plants 16.

The base 20 is comprised of a nonpermeable material and configuration to prevent the fluid 12 and air 14 from escaping out of the reservoir 21 of the base 20 and also to prevent other contaminants from seeping within the reservoir 21 of the base 20. The base 20 may also be comprised of various sizes all which are preferably large enough to contain an adequate amount of fluid 12 to be transferred to the plant bed 70. The base 20 may further be comprised of various shaped configurations, such as but not limited to cylindrical.

### C. Support Column

A support column 24 extends from the base 20 and is preferably utilized to both support the plant bed 70 and a passageway 28 for which the fluid 12 may transfer from the reservoir 21 to the plant bed 70. The passageway 28 preferably extends along a longitudinal axis of the support column 24 and is preferably concentric with the support column 24. The support column 24 is preferably comprised of an elongated and cylindrical configuration. The support column 24 is also preferably concentric with the base 20 and extends vertically upwards from the base 20 as illustrated in FIGS. 1 through 12.

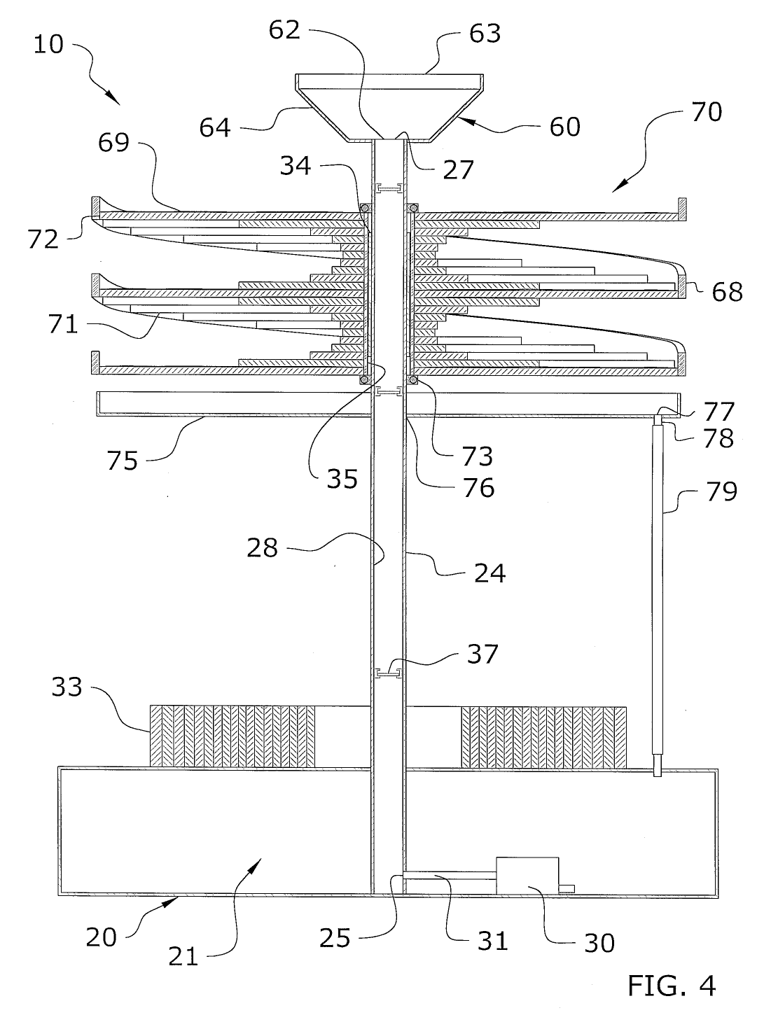

A lower end of the support column 24 is preferably attached within the reservoir 21 of the base 20 as illustrated in FIG. 4. The lower end also preferably includes a plurality of lower openings to allow the fluid 12 and air 14 from within the reservoir 21 or pump 30 to flow within the passageway 28 of the support column 24.

A first lower opening 25 is preferably connected to a connecting hose 31 leading from the pump 30. The fluid 12 or air 14 is then able to flow from the pump 30 to within the passageway 28 of the support column 24 via the connecting hose 31 and the first lower opening 25.

The lower end of the support column 24 may also include a plurality of second lower openings 26 extending through the support column 24 and interconnecting with the passageway 28. The second lower openings 26 preferably fluidly connect the reservoir 21 to the passageway 28 to allow fluid 12 to flow from within the reservoir 21 directly to the passageway 28.

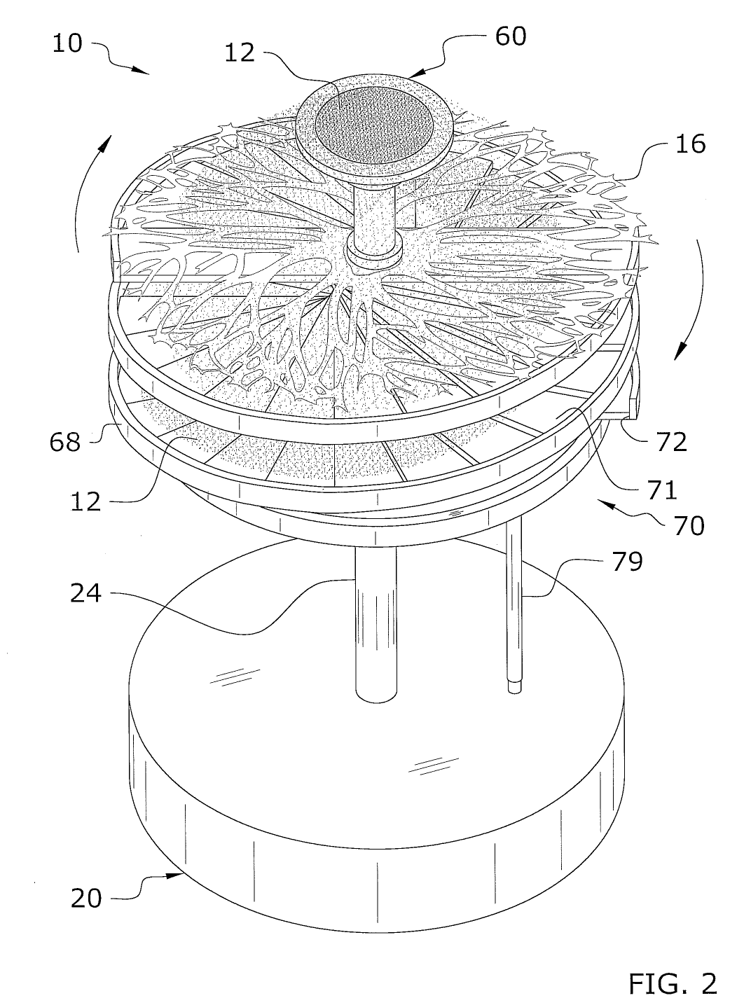

The support column 24 also includes an upper opening 27 to allow the fluid 12 to be released from the support column 24 onto the plant bed 70 as illustrated in FIG. 2. The upper opening 27 preferably extends within an upper end of the support column 24. The upper opening 27 is also preferably concentric with the passageway 28 and the support column 24.

An auxiliary power unit 67 may also radially extend from the support column 24 to provide power to the present invention. The auxiliary power unit 67 is preferably comprised of a plurality of blades to function as a wind generator, wherein the blades of the auxiliary power unit 67 rotate with the plant bed 70.

### D. Pump

The pump 30 transfers the air 14 or the fluid 12 to within the passageway 28 of the support column 24. The pump 30 may include various connecting hoses 31 to fluidly connect the pump 30 to the passageway 28 or the supply hose 79.

The pump 30 may also be comprised of various types of pumps 30 such as an electric pump 30 powered by an AC power supply or a DC power supply (e.g., batteries, coil 34 and magnet 35, solar, wind, etc), a manually driven pump 30 or various others. The pump 30 is preferably positioned within the reservoir 21; however it is appreciated that the pump 30 may be positioned at various places about the present invention.

### E. Electromagnetic Assembly

The present invention may utilize various methods to transfer the fluid 12 from the reservoir 21 to the plant bed 70. The present invention preferably utilizes a method that does not require power from batteries, an AC power supply or various others. The present invention is preferably able to harness energy from various natural sources, such as but not limited to the wind or the sun (i.e. solar power); it is appreciated that the present invention may utilize various types of power supplies, such as but not limited to an AC power supply, batteries or a generator.

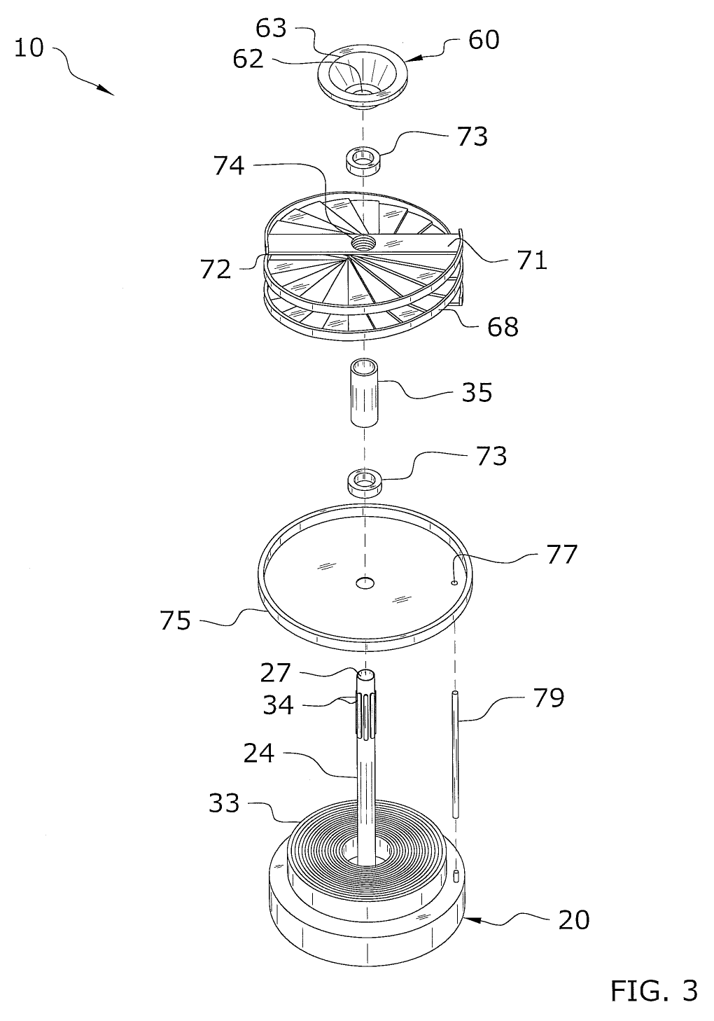

In the preferred embodiment, the present invention includes an electromagnetic assembly 32 to utilize electromagnetics and wind to provide enough power to transfer the fluid 12 from the reservoir 21 to the plant bed 70 via the pump 30 as illustrated in FIGS. 3 and 4. The electromagnetic assembly 32 includes a coil(s) 34 extending around a perimeter of the support column 24 adjacent the plant bed 70. The coil 34 is comprised of an electromagnetic coil 34.

The coil 34 is further preferably positioned adjacent the plant bed 70. The electromagnetic assembly 32 also includes a magnet 35, wherein the magnet 35 rotates around the perimeter of the support column 24 and the coil 34. The magnet 35 preferably rotates along with the plant bed 70 and may be attached to the plant bed 70 or rotatably connected to the support column 24.

The electromagnetic assembly 32 also includes a capacitor 33. The capacitor 33 is preferably comprised of a rolled foil type capacitor 33 and is preferably positioned upon the base 20 adjacent the reservoir 21. The capacitor 33 is electrically connected to the coils 34. It is appreciated that various types of capacitors 33 may be utilized in the coil 34 and magnet 35 assembly. The capacitor 33 is also preferably electrically connected in parallel to the pump 30.

In operation of the electromagnetic assembly 32, the plant bed 70 is rotated by the wind thus causing the magnet 35 to rotate around the coil 34. The coil 34 generates a direct current via the magnet 35 rotating around the coil 34. The current is then transferred to the capacitor 33, wherein the capacitor 33 charges. The capacitor 33 then discharges to the pump 30 to power the pump 30. The pump 30 is then able to operate and transfer the fluid 12 from within the reservoir 21 up through the support column 24 and onto the plant bed 70. This process continues for the duration of the plant bed 70 rotating. It is appreciated that the support column 24 may include a plurality of check valves 37 positioned within the passageway 28 to assist the pump 30 in transferring the fluid 12 from the reservoir 21 to the plant bed 70.

### F. Buoyant Transfer Assembly

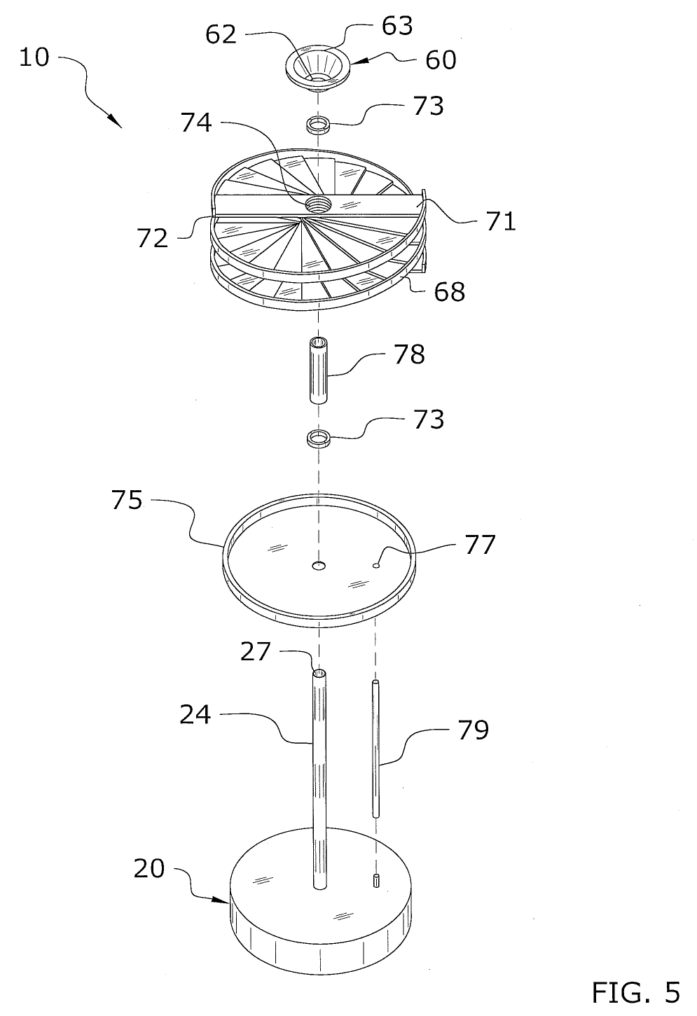

The present invention may alternately or in addition to the electromagnetic assembly 32 include a buoyant transfer assembly 40. The buoyant transfer assembly 40 utilizes the first transfer unit 41 and the second transfer unit 50 to transfer the fluid 12 from the reservoir 21 to the plant bed 70 as illustrated in FIGS. 5 through 12.

The first transfer unit 41 is positioned within a lower end of the support column 24 within the passageway 28. The first transfer unit 41 is fluidly connected to the pump 30 via at least one connecting hose 31. The first transfer unit 41 includes a transfer cavity 42, wherein the transfer cavity 42 receives air 14 and fluid 12 from the pump 30.

The first transfer unit 41 also includes an actuating mechanism 43 connected to an upper end of the first transfer unit 41. Mechanically connected to the actuating mechanism 43 is the first diaphragm 44, wherein upon activation of the actuating mechanism 43 the first diaphragm 44 opens and releases the air 14 from the first transfer unit 41 to within the passageway 28 and subsequently second transfer unit 50.

The second transfer unit 50 is movably positioned or connected within the passageway 28 of the support column 24. The second transfer unit 50 is able to travel along a longitudinal axis of the support column 24 and passageway 28 from a substantial lower end of the support column 24 to a substantial upper end of the support column 24.

The second transfer unit 50 includes an outer shell 51 including a cavity 53. The cavity 53 is preferably open to a lower end of the second transfer unit 50 and openable upon an upper end of the second transfer unit 50 via a first upper diaphragm 55. The second transfer unit 50 also preferably includes a pair 14 of tubular members 52 extending longitudinally through the second transfer unit 50. Each of the tubular members 52 includes a channel 54 longitudinally extending through the respective tubular member 52.

The channels 54 are preferably open to a lower end of the second transfer unit 50 and openable upon an upper end of the second transfer unit 50 via a second upper diaphragm 56. The second transfer unit 50 may also include various retaining members 57 to retain the first upper diaphragm 55 and the second upper diaphragms 56 in position with respect to the second transfer unit 50.

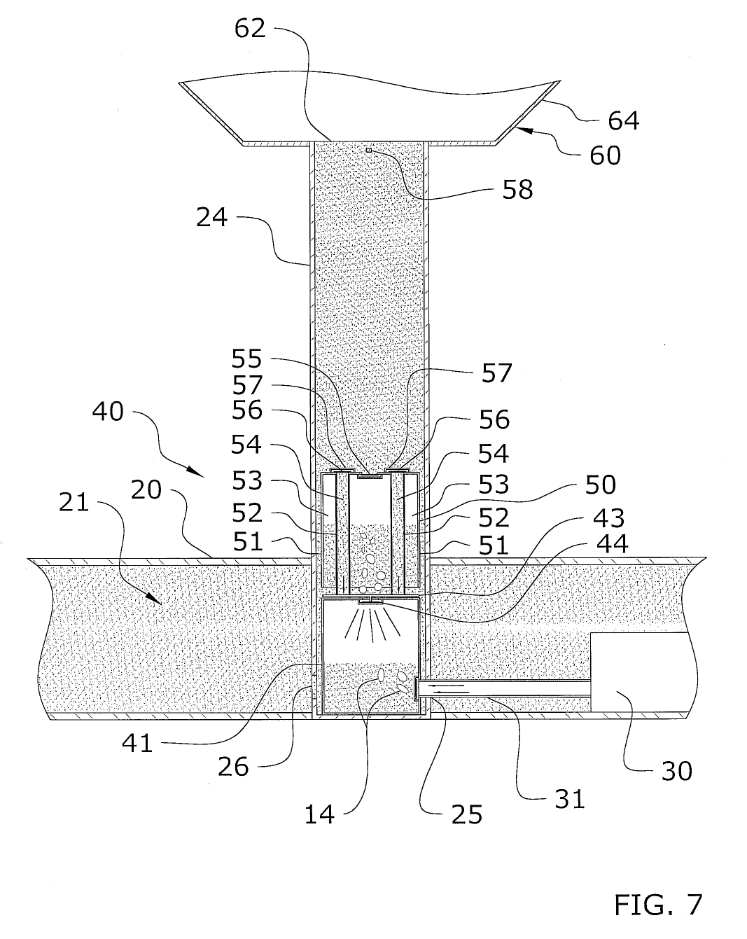

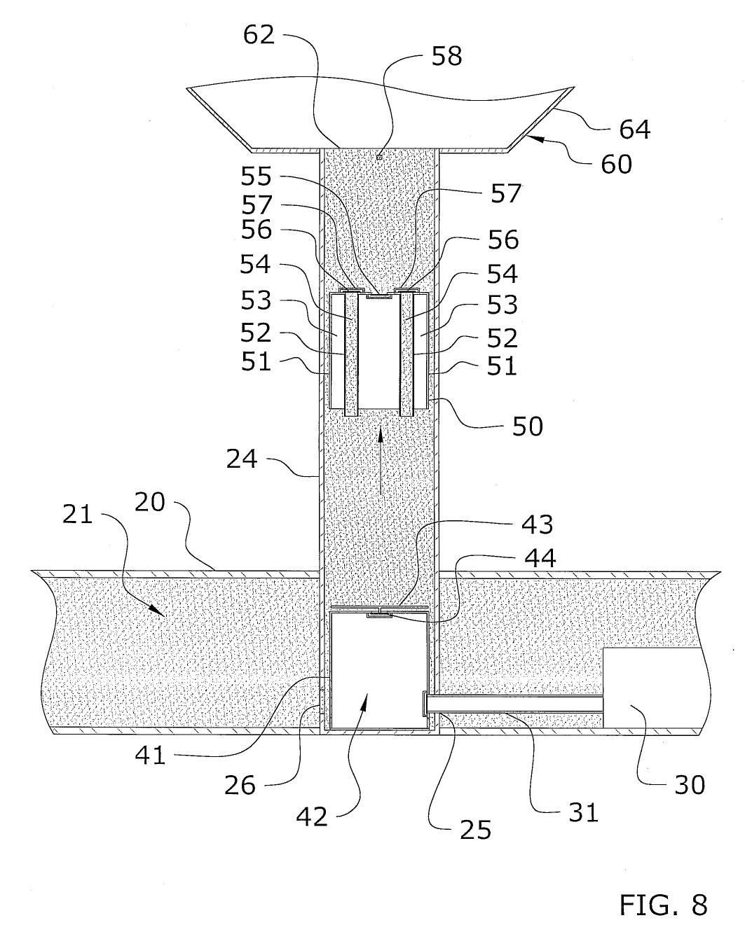

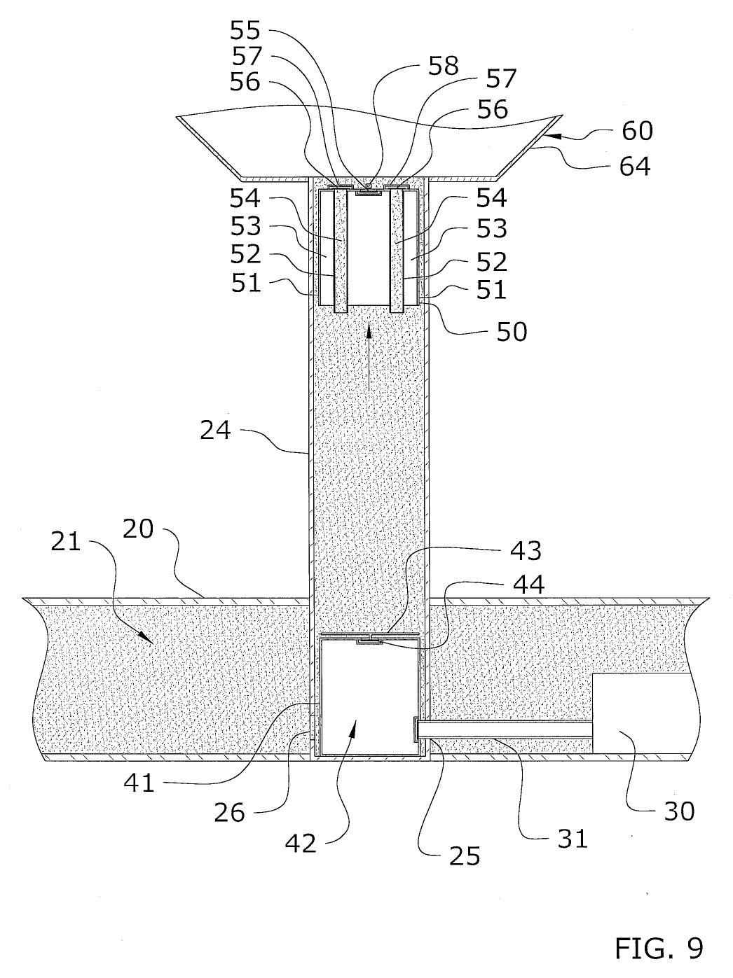

In operation of the buoyant transfer assembly 40, the pump 30 sends air 14 within the first transfer unit 41 and second transfer unit 50 engages the actuating mechanism 43 thus opening the first diaphragm 44 and allowing the air 14 to release from the first transfer unit 41 to within the cavity 53 of the second transfer unit 50 as illustrated in FIG. 7. The first diaphragm 44 now closes as the air 14 within the cavity 53 of the second transfer unit 50 causes the second transfer unit 50 to rise toward the upper end of the support column 24 as illustrated in FIGS. 8 and 9.

As the second transfer unit 50 rises, the upper end of the second transfer unit 50 pushes the fluid 12 between the second transfer unit 50 and the upper end of the passageway 28 upwards and within the overflow unit 60 to subsequently spill over to the plant bed 70. When the second transfer unit 50 reaches the upper end of the passageway 28, the first upper diaphragm 55 engages a stopper member 58 extending within the passageway 28 as illustrated in FIG. 9.

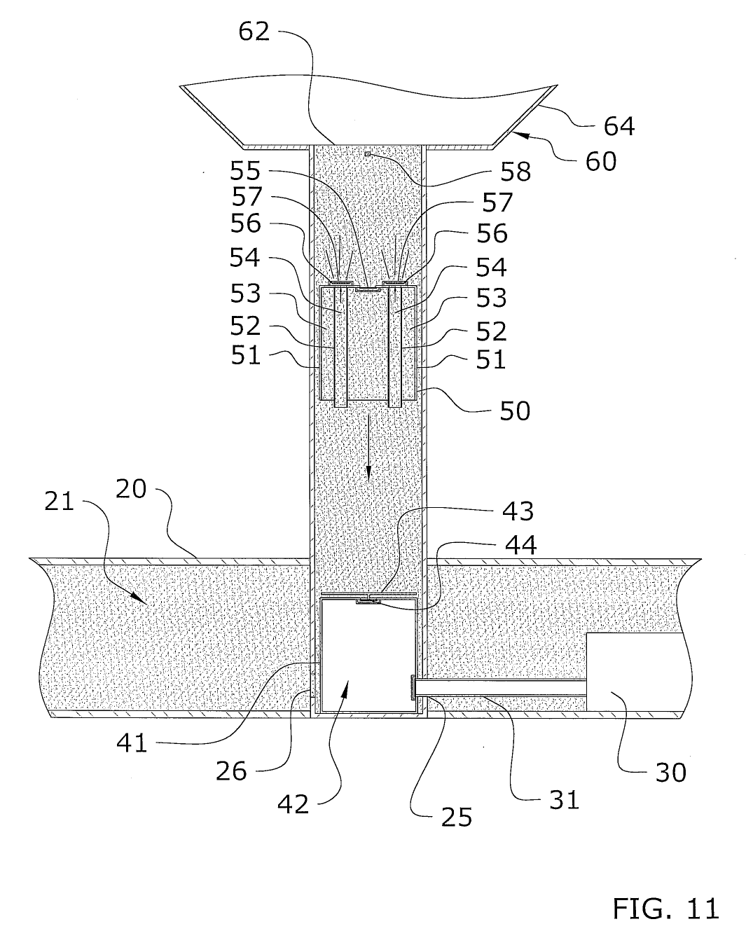

The stopper member 58 pushes on the first diaphragm 44 thus causing the first diaphragm 44 to open the upper end of the cavity 53 to the passageway 28. The fluid 12 is then able to enter within the cavity 53 via a vacuum release caused by the upper end of the cavity 53 opening to the passageway 28. The first upper diaphragm 55 closes after fluid 12 fills within the cavity 53 and the second transfer unit 50 becomes heavier and thus sinks to the lower end of the passageway 28 as shown in FIG. 11.

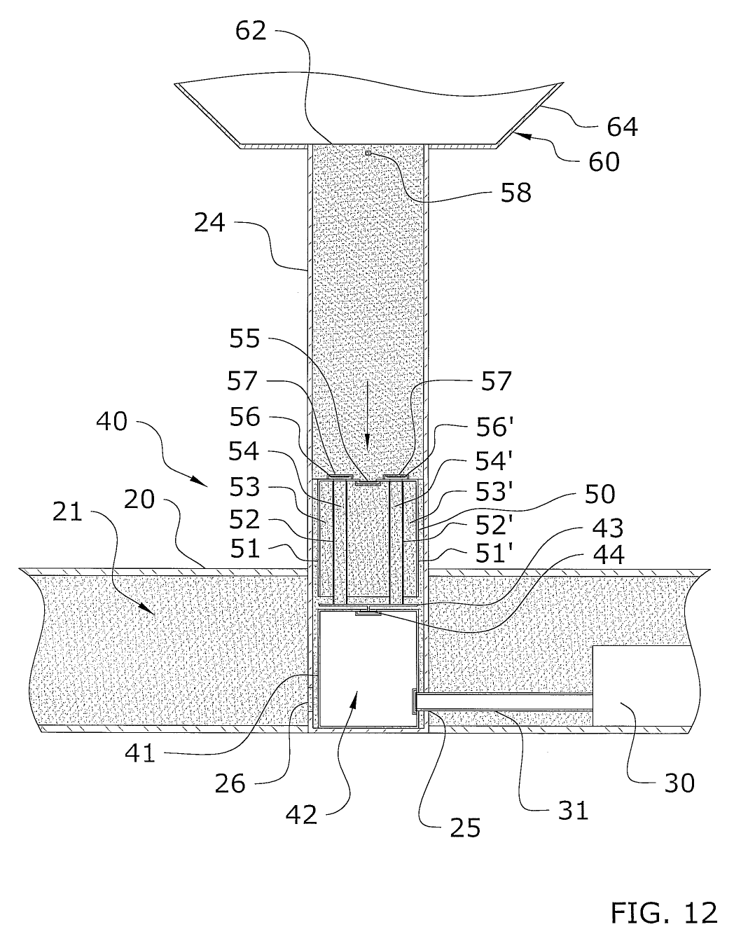

As the second transfer unit 50 sinks, the second upper diaphragms 56 are pushed upwards (via the force of the fluid 12) thus opening the second upper diaphragms 56 and the fluid 12 is able to transfer through the channels 54 thus allowing the second transfer unit 50 to efficiently sink as illustrated in FIG. 11. The second transfer unit 50 continues to sink until the inner members of the second transfer unit 50 once again engage the actuating mechanism 43 thus closing the second upper diaphragms 56 and causing the previously described process to repeat as illustrated in FIGS. 7 and 12.

### G. Overflow Unit

An overflow unit 60 extends from the upper end of the passageway 28 and the support column 24 as illustrated in FIGS. 1 through 4. The overflow unit 60 is preferably concentric with the passageway 28 and support column 24. The overflow unit 60 includes a first opening 62 fluidly connected with the passageway 28. The overflow unit 60 also includes a second opening 63 fluidly connected with the first opening 62, wherein the fluid 12 exits the overflow unit 60 via the second opening 63. The sidewalls 64 of the overflow unit 60 are preferably tapered outwards; however it is appreciated that the sidewalls 64 may be comprised of various configurations.

The overflow unit 60 may also include various electronics, such as a growth rate indicator electrically connected to the plant bed 70 or solar obtaining data. The overflow unit 60 may further include solar cells for the utilization of solar energy. A cover 66 may also extend over the overflow unit 60 to prevent outside elements (e.g. rain, falling leaves, etc.) from falling within the overflow unit 60. The cover 66 may also include solar panels to power the pump 30.

### H. Plant Bed

The plant bed 70 of the present invention radiates outwardly from the support column 24 preferably in a helical manner as illustrated in FIGS. 1 through 4. The plant bed 70 is preferably concentric with the support column 24 and the base 20. The plant bed 70 receives the fluid 12 from the support column 24, wherein various plants 16 are able to be grown hydroponically upon the plant bed 70. It is appreciated that in various alternate embodiments of the present invention, the plants 16 may be grown in other manners rather than hydroponically. The plant bed 70 also preferably defines a double helix configuration.

The fluid 12 is spirally transferred around an upper end of the plant bed 70 towards the lower end of the plant bed 70 and upon the catch tray 75 via gravity. The plant bed 70 preferably includes a plurality of slats 71 extending across the plant bed 70 and oriented to define a helical configuration upon the plant bed 70. The slats 71 are also preferably oriented in a consistent manner so as to allow the wind to efficiently grasp the slats 71 of the plant bed 70 and cause the plant bed 70 to rotate.

The slats 71 are preferably comprised of an elongated rectangular configuration; however it is appreciated that the slats 71 may be comprised of various configurations. The slats 71 also preferably include a central opening 74 extending through the slats 71. The central opening 74 is preferably positioned at a longitudinal center of the slats 71. The slats 71 may be attached directly to the support column 24, an outer cylinder 78 between the support column 24 and the slats 71, the magnet 35 or various other connecting structures all which support the slats 71 about the support column 24.

The slats 71 are also preferably rotatably connected with respect to the support column 24. Various bearing structures 73 may also be attached between the slats 71 and the support column 24 to allow the slats 71 to more easily and smoothly rotate about the support column 24. The outer edges 72 of each of the slats 71 are preferably beveled or curved so that the outer perimeter of the plant bed 70 has a circular configuration. The slats 71 may also be flat or slightly curved. The slats 71 may also be attached to each other in various manners or simply connected to the support column 24.

The slats 71 also preferably include a retaining structure 69 to retain a portion of the fluid 12 upon the upper surface of the slats 71 as the fluid 12 travels along the plant bed 70. The retaining structure 69 extends from the upper surface of the slats 71. The retaining structure 69 may be comprised of various configurations, such as but not limited to a hook and loop configuration, various types of gel or adhesive (e.g. biodegradable, water soluble, etc.) or various other configurations. An outer lip 68 may also extend around the outer edge 72 of the slats 71 of the plant bed 70 to further reduce the amount of fluid 12 that spills off the outer edge 72 of the slats 71,

The catch tray 75 extends outwardly from the support column 24 and is positioned between the plant bed 70 and the reservoir 21 of the base 20. The catch tray 75 is preferably comprised of a circular configuration. The catch tray 75 includes a lip 76 extending upwardly from an outer perimeter of the catch tray 75. The diameter of the catch tray 75 portion adjacent the lip 76 is greater than the outer diameter of the plant bed 70 so that any fluid 12 spilling over the outer edges 72 of the slats 71 falls within the catch tray 75.

The catch tray 75 includes an outer opening 77 extending through the catch tray 75. The supply hose 79 extends from the catch tray 75 adjacent the outer opening 77 and fluidly connects the catch tray 75 to the reservoir 21. The catch tray 75 is fluidly connected to the reservoir 21 via the supply hose 79. The fluid 12 is transferred from the catch tray 75 to the reservoir 21 via the supply hose 79, wherein the fluid 12 is collected by the catch tray 75 after travelling upon the plant bed 70.

It is appreciated that the supply hose 79 may be directly connected to the pump 30, connected to the pump 30 via various connecting hoses 31 or fluidly connected to the reservoir 21. The supply hose 79 may also include a Y shaped educator to both transfer air 14 and fluid 12 to the pump 30 and reservoir 21.

### I. Operation of Preferred Embodiment

In use, the fluid 12 is transferred up through the passageway 28 and spills over the overflow unit 60 onto the plant bed 70. The fluid 12 then spirally travels downward upon the plant bed 70 and around the support column 24 feeding or providing a means for plants 16 to grow upon the slats 71 of the plant bed 70. The fluid 12 then falls upon the catch tray 75, wherein the fluid 12 subsequently enters the supply hose 79 via the outer opening 77. The fluid 12 is then transferred to the reservoir 21, wherein the fluid 12 is gathered within the passageway 28 of the support column 24 and the above described process is repeated.

What has been described and illustrated herein is a preferred embodiment of the invention along with some of its variations. The terms, descriptions and figures used herein are set forth by way of illustration only and are not meant as limitations. Those skilled in the art will recognize that many variations are possible within the spirit and scope of the invention, which is intended to be defined by the following claims (and their equivalents) in which all terms are meant in their broadest reasonable sense unless otherwise indicated. Any headings utilized within the description are for convenience only and have no legal or limiting effect.

I claim:

1. A helical plant growing system, comprising:
a reservoir;
a support column including a passageway, wherein said support column is fluidly connected to said reservoir;
a pump fluidly connected between said reservoir and said support column; and
a plant bed radiating outwardly from said support column opposite said reservoir.

2. The helical plant growing system of claim 1, wherein said plant bed is comprised of a helical configuration.

3. The helical plant growing system of claim 1, wherein said plant bed defines a double helix configuration.

4. The helical plant growing system of claim 1, wherein said plant bed includes a plurality of slats.

5. The helical plant growing system of claim 4, wherein said plurality of slats include a curved outer edge.

6. The helical plant growing system of claim 4, wherein said plurality of slats include a retaining structure extending from an upper surface of said plurality of slats.

7. The helical plant growing system of claim 1, wherein said plant bed is concentric with said support column.

8. The helical plant growing system of claim 1, wherein said plant bed is rotatably connected to said support column.

9. The helical plant growing system of claim 1, including an electromagnetic assembly electrically connected to said pump.

10. The helical plant growing system of claim 1, including a buoyant transfer assembly positioned within said passageway.

11. The helical plant growing system of claim 10, wherein said buoyant transfer assembly includes a first transfer unit and a second transfer unit, wherein said first transfer unit is stationary and wherein said second transfer unit is moves along a longitudinal axis of said passageway.

12. The helical plant growing system of claim 1, including a catch tray positioned between said plant bed and said reservoir.

13. The helical plant growing system of claim 12, wherein said catch tray is fluidly connected to said reservoir.

14. A helical plant growing system, comprising:
a reservoir;
a support column including a passageway, wherein said support column is fluidly connected to said reservoir;
a pump fluidly connected between said reservoir and said support column; and
a plant bed radiating outwardly from said support column opposite said reservoir;
wherein said plant bed is comprised of a helical configuration.

15. The helical plant growing system of claim 14, wherein said plant bed defines a double helix configuration.

16. The helical plant growing system of claim 14, wherein said plant bed is rotatably connected to said support column.

17. The helical plant growing system of claim 14, including an electromagnetic assembly electrically connected to said pump.

18. The helical plant growing system of claim 14, including a buoyant transfer assembly positioned within said passageway.

19. The helical plant growing system of claim 14, including a catch tray positioned between said plant bed and said reservoir.

20. A helical plant growing system, comprising:
a reservoir;
a support column including a passageway, wherein said support column is fluidly connected to said reservoir;
a pump fluidly connected between said reservoir and said support column;
a plant bed radiating outwardly from said support column opposite said reservoir;
wherein said plant bed is comprised of a helical configuration and wherein said plant bed defines a double helix configuration;
wherein said plant bed includes a plurality of slats and wherein said plurality of slats include a curved outer edge;
wherein said plurality of slats include a retaining structure extending from an upper surface of said plurality of slats;
wherein said plant bed is concentric with said support column;
wherein said plant bed is rotatably connected to said support column;
a catch tray positioned between said plant bed and said reservoir wherein said catch tray is fluidly connected to said reservoir; and
an electromagnetic assembly electrically connected to said pump.
